(19) United States
(12) Patent Application Publication
(10) Pub. No.: US 2020/0385068 A1
(43) Pub. Date: Dec. 10, 2020

(54) Hydrogen Discharge System for a Motor Vehicle

(71) Applicant: Bayerische Motoren Werke Aktiengesellschaft, Muenchen (DE)

(72) Inventor: Klaus SZOUCSEK, Haimhausen (DE)

(21) Appl. No.: 16/769,467

(22) PCT Filed: Dec. 3, 2018
(86) PCT No.: PCT/EP2018/083363

§ 371 Date: Jun. 3, 2020

(30) Foreign Application Priority Data
Dec. 4, 2017 (DE) 10 2017 221 849.5

(51) Int. Cl. B62D 25/10; B62D 25/12; B60K 15/03

(52) U.S. Cl. CPC B62D 25/105; B62D 25/12; B60K 15/03; E05Y 2900/536; B60K 2015/03473; B60K 2015/03315; B60K 2015/03026

(57) ABSTRACT

A hydrogen discharge device for a motor vehicle has at least one outlet for hydrogen. The hydrogen discharge device is arranged below the vehicle hood such that when the vehicle hood is closed, the outlet cannot be accessed and when the vehicle hood is open, the outlet can be accessed.

### BACKGROUND AND SUMMARY OF THE INVENTION

The invention relates to a hydrogen discharge device for a motor vehicle, having at least one outlet opening for hydrogen at a body of the motor vehicle. The at least one outlet opening is associated with a hydrogen storage system of the motor vehicle.

U.S. Pat. No. 5,701,928 A describes a system for discharging from a motor vehicle gaseous fuel stored under pressure. For this purpose, the system has a leakage gas line which is guided to the outside through a motor vehicle body and which is connected to various impermeable casings of pressure tank valves and pressure lines and which in this way, via an outgoing-air opening in the vehicle body, vents from the fuel tract of the motor vehicle into the surroundings accumulated gas. The outgoing-air opening in the body, to which the leakage gas line is connected, is situated behind a body flap which is also used for the compressed gas fueling.

Connections for the emptying of hydrogen tank systems are normally situated in the underfloor of motor vehicles. DE 602 06 214 T2 describes such a motor vehicle having a hydrogen tank system for a fuel cell system.

Such emptying connections in the underfloor are often difficult to access when the motor vehicle is standing on the ground, since it is necessary to reach under the motor vehicle for this purpose. Moreover, such a connection has to be protected against unauthorized access, for example by means of a lock or special tool. For the purpose of emptying, a tube leading to an extraction device is normally connected to the emptying connection.

It is an object of the invention to design and arrange a hydrogen discharge device for a motor vehicle such that the simple, quick and safe handling of the hydrogen discharge device is ensured.

The object is achieved according to the invention by a hydrogen discharge device for a motor vehicle, having at least one outlet opening for hydrogen. The hydrogen discharge device is arranged below the engine hood in relation to the outlet opening such that, when the engine hood is closed, the outlet opening is not accessible and, when the engine hood is open, the outlet opening is accessible.

This has the advantage that, for the outlet opening, no securing measures, for example by way of a lock, are necessary to protect against unauthorized access. This function is performed by the engine hood securing device already present at the motor vehicle.

In one advantageous configuration of the invention, the outlet opening is arranged on the engine hood such that the outlet opening is moved upward during the opening movement of the engine hood and is positioned no less than 190 centimeters above the ground when the engine hood is fully open.

In this way, it is advantageously possible for hydrogen to be blown off outside into the surroundings without use of a separate blow-off tube and a blow-off chimney for overhead height. This makes it possible to omit work steps and yields good accessibility with an ergonomic working posture for the person carrying out defueling with hydrogen.

Preferred embodiments of the invention provide that the outlet opening is seated at the end of an outlet line which is guided below the engine hood and whose other end is connected to a valve device having valves arranged serially one after the other, these being, following the other end, a throttle valve, a shut-off valve and a check valve. By means of these valves, simple and reliable operation of the discharge device is ensured, especially if at least one hydrogen discharge line is connected to the valve device so as to serially follow the check valve.

The shut-off valve may advantageously also be designed such that, for example by way of a correspondingly small seat diameter, after the opening, it also acts as a throttle and in this way performs the throttling function of the throttle valve, which can then be dispensed with.

If the check valve is, via its outlet opening, a connection valve of the valve device for a further hydrogen discharge line, which is able to be connected, so as to serially follow the check valve, to the outlet opening of the latter, this has the advantage that a blow-off chimney of a building can be connected to the valve device in a simple manner, for example during servicing in a workshop, for the purpose of discharging hydrogen via the further hydrogen discharge line. The check valve can then be opened either actively by an operating person by way of a corresponding device or already by way of the connection of the hydrogen discharge line after sealing of the connection. In this way, it is also advantageously the case that a complete defueling operation is certainly able to be carried out.

Furthermore, it is advantageous if the hydrogen outlet line or the hydrogen discharge line is guided, at least over a certain length, along a fastening point of the engine hood for the movable fastening thereof and, at least there, is of elastic form. In this way, it is easily possible for one or the other line to be fastened to the engine hood, and for the engine hood still to be designed to be swingable, for example in the vicinity of the lower edge of the windshield. Here, it is highly advantageous if the hydrogen outlet line and/or the hydrogen discharge line consist(s) of elastic, non-flammable plastic.

It is particularly advantageous if the valve device is attached below the engine hood, so as to be accessible in the open position of the latter, such that it can be actuated manually by an operating person. In particular, the valve device may be attached below the engine hood to the latter.

The invention will be discussed in more detail below on the basis of a preferred exemplary embodiment, wherein the appended FIGS. 1 and 2 illustrate a discharge device according to the invention on a motor vehicle which is not illustrated in full. All of the features described in more detail may be essential to the invention.

### BRIEF DESCRIPTION OF THE DRAWINGS

FIG. 1 shows a motor vehicle with a hydrogen discharge device according to an embodiment of the invention for components (not shown) of a hydrogen drive, in particular for use during defueling of a hydrogen pressure store (not shown).

FIG. 2 shows a valve device as a detail from FIG. 1 in a longitudinal section.

FIG. 3 shows the motor vehicle from FIG. 1 with a hydrogen discharge device according to an embodiment of the invention which is in a different place in the so-called engine compartment.

### DETAILED DESCRIPTION OF THE DRAWINGS

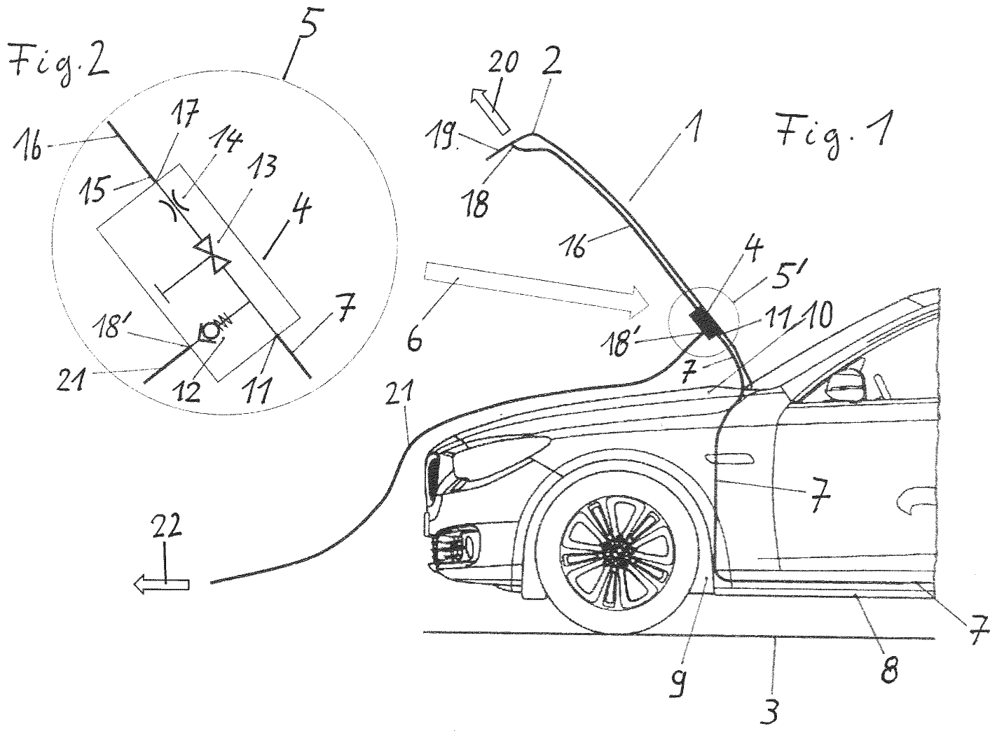

FIG. 1 shows parts of a hydrogen discharge device on a partly drawn motor vehicle front section with fully open engine hood 1, the highest exposure 2 thereof in this position being in reality approximately two meters above a base line 3, the symbolically illustrated roadway of the motor vehicle. Attached to the lower side of the engine hood 1 is a valve device 4, which, in order to be more clearly recognizable, has been cut-out from FIG. 1 and illustrated on an enlarged scale in FIG. 2, this being indicated symbolically by two encircling circles 5, 5′ and an arrow 6.

A hydrogen discharge line 7 is also indicated symbolically on the outside of the motor vehicle front section. The hydrogen discharge line 7 is guided, so as to run within the body, from at least one hydrogen pressure storage tank (not shown) in the rear section, and then along the underbody 8 of the motor vehicle up to a wheel arch 9, and then from the at the wheel arch upward in the engine compartment 10 below the engine hood 1 to the valve device 4 and 11 connected to the valve device 4 at a connection 11.

FIG. 2 illustrates the valve device 4 on an enlarged scale, a check valve 12, a shut-off valve 13 and a throttle valve 14 being arranged serially one after the other therein proceeding from a connection 11 of the hydrogen discharge line 7 to the valve device 4, wherein the throttle valve is connected via a further connection 17 of the valve device 4 to another end 15 of an outlet line 16 guided below the engine hood 1. This outlet line 16 ends with an outlet opening 18 at a front end 19 of the engine hood 1 such that the outlet opening 18 is directed into the atmosphere in order, there, to be able to release into the surroundings hydrogen to be blown off, this being identified symbolically by an arrow 20. For this purpose, it is then necessary for the shut-off valve 13 to be opened.

By way of the valve device 4, it is possible, in addition to this outlet line 16 with outlet opening 18 for hydrogen which is to be blown off into the environment, also to blow off hydrogen in a building, for example during servicing in a workshop, in that the check valve 12 of the valve device 4 is connected to one end of a further hydrogen discharge line 21. The other end thereof is connected to a blow-off chimney of the building (not shown) for the purpose of discharging the hydrogen, illustrated symbolically by a further arrow 22.

In their simplest form, the hydrogen outlet line 16 and the hydrogen discharge line 7 are designed as flexible pressure lines which may consist for example of an elastic, non-flammable plastic. It is then possible for the hydrogen discharge line 7 to be guided, at least over a certain length, on a fastening point (not drawn) of the engine hood 1, in particular on a hinge of the engine hood 1, for the movable fastening thereof.

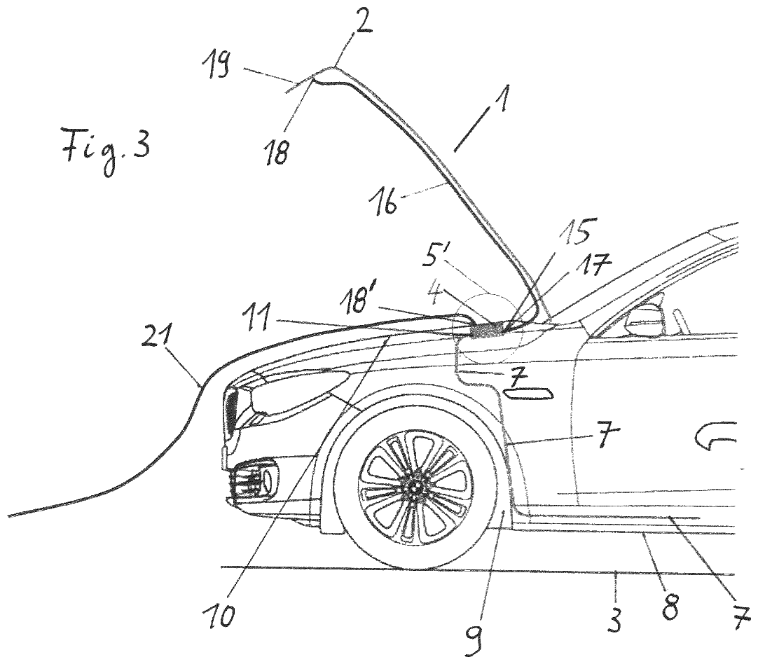

By contrast to FIG. 1, FIG. 3 illustrates an embodiment of the invention in which the valve device 4 is attached below the engine hood 1 in the engine compartment, so as to be accessible to an operating person in the open position of the engine hood, such that the valve device can be actuated manually. For example, the valve device may be fastened at the top to a bulkhead (not illustrated) or to a suspension-strut dome (not illustrated) of the motor vehicle. The check valve 12 (FIG. 2) of the valve device 4 is, via the outlet opening 18′, also a connection for the further hydrogen discharge line 21, which is able to be connected to the outlet opening 18′ so as to serially follow the check valve 12 by the operating person, for example for defueling a hydrogen store. For this purpose, the check valve 12 has to be subsequently opened. The illustration of details in FIG. 2 is equally applicable to FIG. 3 as it is to FIG. 1.

The further hydrogen discharge line 21, with its free, other end, can, for the purpose of discharging the hydrogen, be connected preferably to a blow-off chimney of the building (not shown). Normally, the hydrogen discharge line 21 is then not part of the motor vehicle, but rather part of a discharge line crane (not illustrated) which is installed in the building and which, in particular inter alia, provides, at least in a pivotable manner, in particular overhead, the hydrogen discharge line 21 for use at the outlet opening (18′) of the valve device (4). Here, by way of its sealing connection to the hydrogen discharge line 21 via the outlet opening 18′, the check valve 12 can be opened already automatically, triggered by a mechanical or an electrical control device, or else by a separately required opening action by an operating person.

1.-9. (canceled)

10. A hydrogen discharge device for a motor vehicle having an engine hood, comprising:
at least one outlet opening for hydrogen, wherein
the hydrogen discharge device is arranged below an engine hood in relation to the engine hood such that, when the engine hood is closed, the outlet opening is not accessible and, when the engine hood is open, the outlet opening is accessible.

11. The hydrogen discharge device according to claim 10, wherein
the outlet opening is arranged on the engine hood such that the outlet opening is moved upward during an opening movement of the engine hood and is positioned no less than 190 centimeters above ground when the engine hood is fully open.

12. The hydrogen discharge device according to claim 10, wherein
the outlet opening is seated at an end of an outlet line which is guided below the engine hood, and
the other end of the outlet line is connected to a valve device having valves arranged serially one after the other, said valves being, in order from the other end, a throttle valve, a shut-off valve and a check valve.

13. The hydrogen discharge device according to claim 12, wherein
the shut-off valve is configured so as to be a throttle.

14. The hydrogen discharge device according to claim 12, wherein
the check valve is, via the outlet opening of the valve device, a connection valve for a further hydrogen discharge line, which is able to be connected to the outlet opening so as to serially follow the check valve.

15. The hydrogen discharge device according to claim 10, wherein
a hydrogen outlet line or a hydrogen discharge line is guided, at least over a certain length, on a fastening point of the engine hood for movable fastening thereof to the motor vehicle and, at least there, is of elastic form.

16. The hydrogen discharge device according to claim 15, wherein
the hydrogen outlet line and/or the hydrogen discharge line are made of an elastic, non-flammable plastic.

17. The hydrogen discharge device according to claim 12, wherein
the valve device is attached below the engine hood, so as to be accessible in the open position of the engine hood, such that the valve device is actuatable manually.

18. The hydrogen discharge device according to claim 12, wherein
the valve device is attached below the engine hood to the engine hood.

19. A hydrogen discharge device for a motor vehicle having a flap, comprising:
at least one outlet opening for hydrogen, wherein
the hydrogen discharge device is arranged behind the flap in relation to an externally viewed portion of the flap of the motor vehicle,
when the flap is closed, the outlet opening is not accessible externally, and
when the flap is open, the outlet opening is accessible.

20. The hydrogen discharge device according to claim 19, further comprising:
a valve device comprising a throttle valve, a shut-off valve and a check valve arranged serially one after the other;
a hydrogen outlet line guided behind the flap, one end of the hydrogen outlet line being the outlet opening, and the other end of the hydrogen outlet line being connected to the throttle valve of the valve device.

21. The hydrogen discharge device according to claim 20, further comprising:
a further hydrogen discharge line, wherein
the further hydrogen discharge line is connected to the check valve functioning as a connection valve, and
the other end of the further hydrogen discharge line being an outlet opening.

22. The hydrogen discharge device according to claim 10, wherein
the flap is an engine hood, and
the hydrogen discharge device is arranged behind the engine hood and below the engine hood.
